(19) United States
(12) Patent Application Publication
(10) Pub. No.: US 2025/0110010 A1
(43) Pub. Date: Apr. 3, 2025

(54) DEVICE WITH LEAK DETECTION OF A DRIPABLE MEDIUM FOR A MOTOR VEHICLE

(71) Applicant: MAN Truck & Bus SE, München (DE)

(72) Inventors: Rainer Kalaß, Rohr (DE); Kristijan Begic, München (DE)

(21) Appl. No.: 18/696,784

(22) PCT Filed: Sep. 23, 2022
(86) PCT No.: PCT/EP2022/076481

§ 371 Date: Mar. 28, 2024

(30) Foreign Application Priority Data
Sep. 30, 2021 (DE) 10 2021 125 363.2

(51) Int. Cl. G01M 3/18

(52) U.S. Cl. CPC G01M 3/186

(57) ABSTRACT

The invention relates to a device (10) with leak detection for a medium (14) capable of forming drops for a motor vehicle, preferably utility vehicle. The device (10) comprises a container (12) for receiving the medium (14) capable of forming drops, preferably a non-conductive medium (14) capable of forming drops, and an electrical conductor (16) which is guided through a sealed-off conductor bushing (32) of the container (12). The device (10) further comprises a detection device (20), which is arranged outside the container (12), for detecting a leak in the conductor bushing (32) through which the medium (14) capable of forming drops emerges from the container (12) along the electrical conductor (16).

The invention relates to a device with leakage detection of a dripable medium for a motor vehicle, and to a motor vehicle comprising the device.

Motor vehicles, preferably motor vehicles operated with diesel fuels, require additional electrical heating during winter operation to prevent ice crystal formation and kerosene formation, particularly at temperatures below 0° C., and when using winter diesel, at the latest below −22° C. The electrical heating energy introduced prevents the fuel fine filter from clogging, at least for a certain temperature range, depending on the electrical capacity and flow rate.

These heaters are configured with a heating element in PTC technology (PTC: “positive temperature coefficient”), comprise integrated power and control electronics and are still used today in utility vehicles, for example.

The electrically conductive connection between the heating element located directly in the fuel and the electronics arranged outside the tank must be equipped with a permanent seal to prevent fuel leakage.

The housings used in the state of the art or tanks made of plastics and the sealing materials made of elastomers (primary seals) are subject to a degradation of the intended properties and functions of these materials over the service life and over time. From an economic point of view, it is difficult to ensure the fatigue strength of these components, so that components are developed with operating strengths based on known physical loads (environmental influences, thermal stress, vibrations). Furthermore, these types of designs will continue to be used in line with the selected materials on the basis of positive laboratory tests and field trials and for reasons of optimized unit costs.

The long-term durability of the fuel leakage seal on a properly manufactured fuel heater is also highly dependent on the severity of the applications. This means that although known and foreseeable physical and physical environmental stresses are well taken into account during development, the actual stresses occasionally exceed the test parameters. In addition, deviations may occur in the manufacturing process (i.e. fluctuations in production quality) that may not be detected in the EOL test (EOL: “end of life”) and thus shorten the expected service life. Primary seals may also fail after a long period of use and near the end of the economic life of these components. It is not possible to fully predict or safeguard against this. The primary seal, such as an elastomer potting compound, detaches from the mating parts to be sealed in this case, and the fuel heater begins, usually unnoticed by the user, to increasingly emit fuel into the environment.

Furthermore, this problem is not limited to fuel heaters.

For example, cooling and temperature control processes for traction batteries (secondary batteries) in electrically powered motor vehicles are known under the general term “immersion cooling”, in which the electrical storage cells are directly surrounded by transformer oil for temperature control. The transformer oil has almost the same properties as diesel fuels, namely the special property of high electrical resistance (insulator).

The electrical interfaces of these traction batteries are diverse and include, for example, electrical connectors (high-voltage connections, low-voltage connections) made of, for example, polymer-extruded copper strands. The spaces between the copper strands, which consist of fine round wires, are permeable to dripping media such as transformer oil, whereby an insulator surrounding the copper strands can also act as a hose system for the transformer oil. These electrical connectors must therefore be equipped with seals to prevent the transformer oil from entering. These seals also degrade over the service life, the severity of the applications and purely over time.

It is therefore an object of the invention to provide an improved technique for better handling a possible leakage of a dripable medium in a motor vehicle, which at least partially avoids the disadvantages of known approaches. In particular, it is an objection of the invention to provide a device with leakage detection of a dripable medium for a motor vehicle, which enables an early reaction to a degradation of the seal used and thus to an escape of the dripable medium in the event of a leakage.

This objective is solved by the features of the independent claims. Advantageous further embodiments are given in the dependent claims and the description.

According to a first general aspect of the invention, a device with leakage detection of a dripable medium (i.e. a liquid) for a motor vehicle, preferably a utility vehicle, is provided. The device comprises a container (e.g. made of plastic) for holding the dripable medium, preferably a non-conductive (i.e. non-electrically conductive) dripable medium. The term “non-conductive” includes not only electrically insulating media, but also includes dielectric (and/or high resistance) media. The device further comprises an electrical conductor (e.g. made of copper) passing through a sealed conductor bushing of the container. The device further comprises a detection device arranged outside the container for detecting a leakage in the conductor bushing. In the event of a leakage, the dripable medium escapes from the container along the electrical conductor. The leakage may preferably be a leakage in the conductor bushing through which the dripable medium escapes from the container along the electrical conductor. Preferably, the leakage is a detachment area (which develops over the service life of the device) between a sealing compound for sealing the conductor bushing and the electrical conductor.

The detection device is conveniently arranged at a position where it can detect (determine, detect, sense) the dripping medium escaping through the conductor bushing in the event of leakage. Preferably, this is a position at which the detection device may detect the leaking dripping medium before the leaking dripping medium can leave the device (is discharged into the environment). Preferably, the detection device is arranged at a position such that, in the event of a leakage, it comes into contact with the dripable medium escaping through the conductor bushing (e.g. contamination of the detection device with the dripable medium occurs).

According to the present disclosure, a device is thus provided that provides early detection of a leakage in a conductor bushing before the dripable medium escaping in the event of the leakage is released into the environment. The device takes into account, among other things, that the leakage occurs during the ongoing use of the device, especially due to the fact that the sealing within the conductor bushing detaches from the mating parts to be sealed, especially the electrical conductor passed through the conductor bushing. Such a leakage is characterized accordingly by the fact that the dripable medium in the detachment area (e.g. cracks, blowholes) escapes from the container along the electrical conductor. In particular, the device disclosed herein is configured to detect such leaks.

Furthermore, the present disclosure provides a technique for leakage detection, whereby already existing arrangements within a motor vehicle, e.g. a fuel tank with a fuel heater, may be retrofitted with a detection device configured according to the disclosure.

According to a particularly preferred embodiment, the electrical conductor outside the container may be surrounded (e.g. embedded, overmolded) at least in sections by the sealing compound (e.g. an elastomer sealing compound, potting compound), the sealing compound being preferably a permanently elastic sealing compound and/or a sealing compound that adjoins the container (sealingly), for sealing the conductor feedthrough. The electrical conductor may also be surrounded by the sealing compound inside the conductor bushing. Alternatively or additionally, a further sealing element or sealing compound may be arranged inside the conductor bushing to seal it. The detection device may be configured to detect the leakage on the basis of the dripping medium that has penetrated into a portion (in particular the detachment area) between the electrical conductor and the sealing compound. The additional arrangement of the sealing compound outside the conductor bushing advantageously leads to an improved seal, whereby, among other things, the detachment areas along the electrical conductor, which are necessary for the dripable medium to leave the device and be released into the environment, are enlarged. Furthermore, the electrical conductor may thus be protected from further external influences by the sealing compound.

According to a further preferred embodiment, the detection device with the electrical conductor may be surrounded by the sealing compound at least in sections. The sealing compound may thus advantageously serve as a retaining means for the detection device. An arrangement of the detection device within the sealing compound also has the advantage that no detachment areas leading directly to the outside may form between the detection device and the sealing compound, through which the dripable medium may be separated to the environment in the event of a leakage before the leakage is detected.

According to a further embodiment, the electrical conductor may be electrically connected to an electrotechnical element outside the container. The electrotechnical element may provide an electrical energy source for the electrical supply of the detection device. Alternatively or additionally, the electrotechnical element may comprise an (electrical and/or data) interface for the electrical supply of the detection device (e.g. by means of a motor vehicle power supply) and/or for data communication between the detection device and an external communication system (e.g. a motor vehicle control unit). The detection device may be arranged on the electrical conductor, at a transition point from the electrical conductor to the electrotechnical element and/or on the electrotechnical element. Advantageously, the detection device may thus be positioned at expected detachment areas along the electrical conductor or the electrotechnical element in order to be able to detect the dripable medium that has penetrated into the detachment areas.

According to a further embodiment, the electrotechnical element with the detection device may be surrounded (at least in sections) by the sealing compound, preferably in such a way that, in the event of leakage, the dripping medium spreads at least partially on a surface of the electrotechnical element and may be detected by the detection device, which is preferably arranged on the electrotechnical element. The arrangement of the electrotechnical element within the sealing compound advantageously leads to a further improvement in sealing, as the detachment areas along the electrical conductor and subsequently along the electrotechnical element, which are necessary for the dripable medium to leave the device and be released into the environment, are further increased. Furthermore, the electrotechnical element can thus be protected from further external influences by the sealing compound.

According to a further embodiment, the electrotechnical element may comprise a printed circuit board. The printed circuit board may preferably be electrically connected to the electrical conductor by means of a press-fit connection.

According to a particular embodiment, the leakage may be detectable by detecting a change in the electrical conductivity of the detection device when contaminated with the dripable medium. The change in electrical conductivity may be determined, for example, by a measurable change in an applied electrical voltage. The detection device may, for example, be configured in accordance with one of the following three embodiments.

According to the first embodiment, detection device may comprise two electrical contacts and an insulator, which is arranged between the electrical contacts and is configured to dissolve when contaminated with the dripable medium. The contacts may be force-loaded, preferably in such a way that contacting of the electrical contacts occurs and thus the electrical conductivity of the detection device changes when the insulator dissolves. The contacting of the electrical contacts may (irreversibly) close a normally open circuit.

According to the second embodiment, the detection device may comprise an electrode arrangement with a material (e.g. a dry insulator or dielectric) arranged within the electrode arrangement. A permittivity of the material may be altered by contamination with the dripable medium, thereby altering the electrical conductivity of the detection device. Preferably, the material may become electrically conductive as a result of the contamination.

According to the third embodiment, the detection device may comprise a resonant circuit with the electrode arrangement. Preferably, the permittivity of the material may be changed by the contamination with the dripable medium and thus a resonant circuit frequency shift may be detected.

The three embodiments thus form (partial) circuits which, on the one hand, may be implemented in a simple manner and, on the other hand, a leakage may be detected in a simple manner by applying current and determining a change in the electrical conductivity in the event of contamination, in particular of the insulator or material used, with the dripable medium. For implementation, the material of the insulator or the material may be expertly selected according to the application.

According to a further embodiment, the detection device may further comprise a control unit which is connected to a motor vehicle control unit for the transmission of detection information in terms of signal technology and/or is electrically connected to a motor vehicle power supply.

The control unit may be configured to apply electrical current to the electrical contacts and/or the cathode arrangement of the detection device. The control unit may be supplied with electrical current from the vehicle power supply and/or a (separate) electrical current source of the detection device. The electrical connection to the vehicle power supply has the advantage that the detection device does not require its own power supply to energize the electrical contacts or the cathode arrangement and, for example, an interface already provided by the electrotechnical element may be used for the electrical connection to the vehicle power supply. Having its own electrical power source has the advantage that the detection device may be positioned independently of the position of the vehicle power supply and no additional cabling is required between the detection device and the vehicle power supply.

The detection information may in particular include information that a leakage has been detected. The detection device may be configured to send the detection information, preferably exclusively, to the motor vehicle control unit in the event of a leakage detection (i.e. to report the presence of the leakage to the motor vehicle control unit). The detection information may, for example, be sent to the vehicle control unit via a vehicle electrical system. The detection information may also be read out via the vehicle control unit (e.g. by means of a service and diagnostic system that may be connected using signal technology).

Alternatively or additionally, the motor vehicle control unit may be configured to send a control signal to a display device, preferably arranged in the vehicle interior, particularly preferably on the dashboard, to output a warning. The motor vehicle control unit may be configured in particular to send the control signal (exclusively) when detection information that a leakage has been detected has been received. In particular, the warning can include the fact that a leak has been detected.

As an alternative or in addition to transmitting the detection information to the motor vehicle control unit, the control unit may also be configured to transmit the detection information, preferably directly and/or wirelessly, to a display device, e.g. a portable display device. The display device may be configured to output the warning when the detection information has been transmitted.

The transmission of the detection information thus advantageously result leads in a user, e.g. the driver or a specialist for service or maintenance work, being warned of the detected leakage at an early stage and being able to initiate appropriate measures (e.g. repair or replacement of the defective seal) before the dripable medium escapes into the environment. Furthermore, an infrastructure already present in the vehicle, e.g. an interface already provided by the electrotechnical element, can advantageously be used for data communication with the vehicle control unit.

According to a further embodiment, the control unit may also be configured to determine the change in the electrical conductivity of the detection device and preferably to detect the leakage based on the change in electrical conductivity. For this purpose, the control unit may comprise evaluation electronics. The change in electrical conductivity is determined (in time) while the electrical contacts and/or the cathode arrangement of the detection device are electrically energized. The control unit may also be configured to carry out the determination of the change in electrical conductivity (and preferably the electrical loading of the electrical contacts and/or the cathode arrangement of the detection device) continuously, regularly (periodically) and/or at predetermined times (e.g. at the start of operation of the motor vehicle).

According to a particular embodiment, the device may be a fuel tank device. The container may be a fuel tank (e.g. a pressurized chamber) for holding a fuel, preferably a diesel fuel, as the dripable medium. The electrotechnical element may comprise power and/or control electronics of a fuel heater electrically connected via the electrical conductor to a heating element arranged within the fuel tank, preferably with a positive temperature coefficient. In this way, an existing fuel tank with a fuel heater may be advantageously retrofitted with the detection device in order to provide the leakage detection function.

According to another special embodiment, the device may be a traction battery device. The container may be a housing of the traction battery device in which electrical storage cells are surrounded by a coolant, preferably a transformer oil, as the dripable medium for cooling. The electrical conductor may comprise a high-voltage and/or a low-voltage connection.

Alternatively or additionally, the electrotechnical element may comprise electronics and/or a connector. Furthermore, alternatively or additionally, the electrical conductor may comprise individual conductors and/or, preferably polymer-extruded, copper strands. Thus, an already existing traction battery device may advantageously be retrofitted with the detection device in order to be able to provide the function of leakage detection.

According to a further general aspect of the invention, a motor vehicle, preferably a utility vehicle, is provided with a device as disclosed herein.

The embodiments, variants and features of the invention described above may be combined with each other as desired. Further details and advantages of the invention are described below with reference to the accompanying drawings. The following figures show:

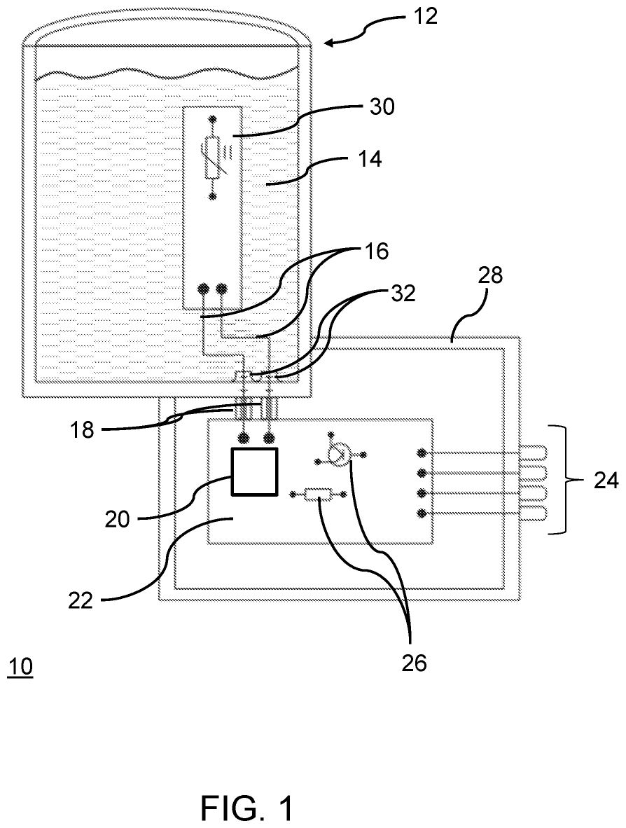

FIG. 1 a schematic view of a device according to an embodiment;

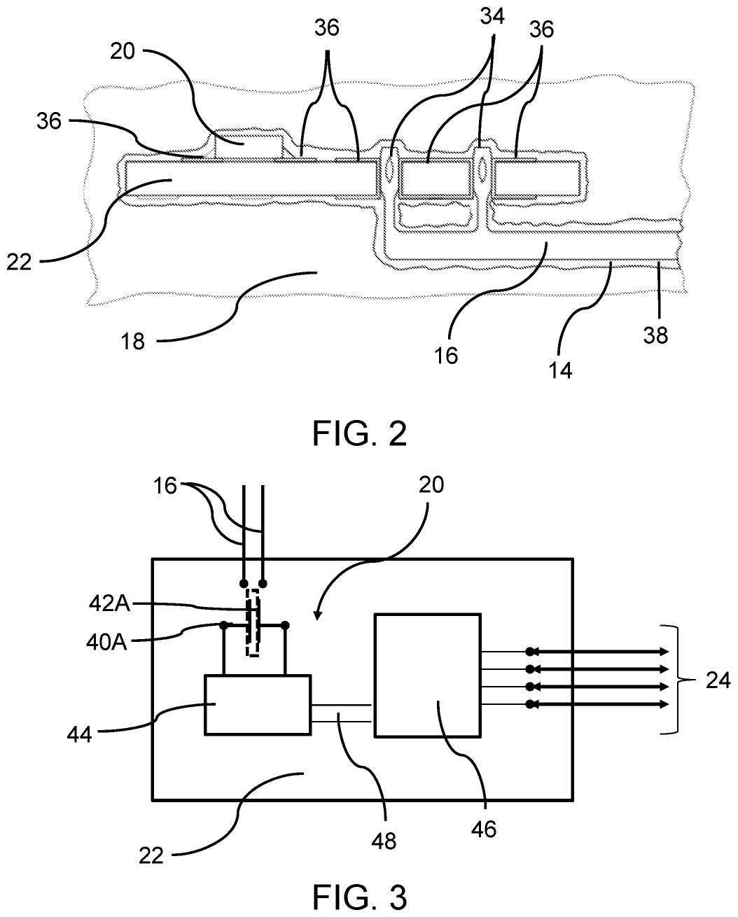

FIG. 2 a view of a part of the device outside the container in the event of a leakage according to an embodiment;

FIG. 3 a schematic view of an electrotechnical element with a detection device according to an embodiment; and

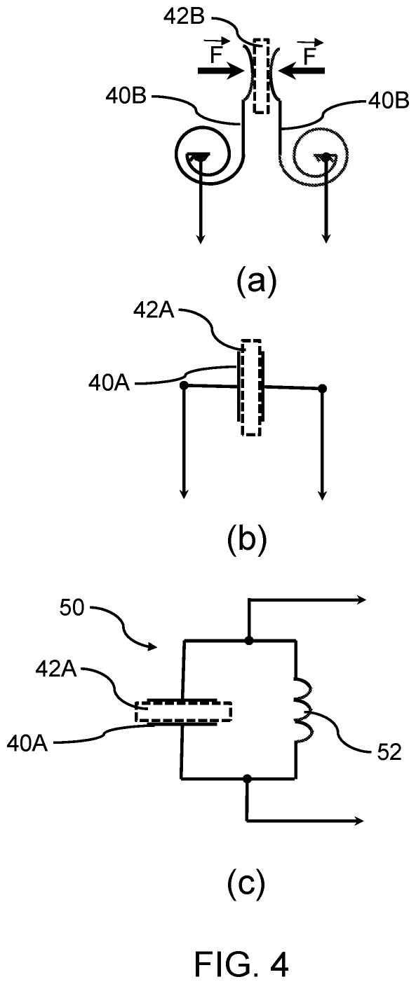

FIG. 4 schematic views of several embodiments of elements of the detection device.

FIG. 1 shows a device 10 with leakage detection of a dripable medium 14 according to an embodiment. The device 10 comprises a container 12, an electrical line 16 and a detection device 20.

The container 12 serves to hold the dripable medium 14, preferably a non-conductive dripable medium, for example a diesel fuel or a transformer oil.

The electrical conductor 16 is passed through a sealed conductor bushing 32 of the container 12. Furthermore, the electrical conductor 16 is surrounded outside the container 12, at least in sections, by a sealing compound 18 for sealing the conductor bushing 32.

With ongoing use and stress, the sealing compound 18 may become detached from the joining partner to be sealed, i.e. the electrical conductor 16, so that a leakage may occur in the conductor bushing 32 and in particular along the electrical conductor.

To detect such a leakage, the detection device 20 is therefore arranged outside the container 12 so that the detection device 20 may detect a leakage when the dripable medium 14 escapes from the container 12 along the electrical conductor 16 through the conductor bushing 32.

In the embodiment shown, the detection device 20 is arranged on an electrotechnical element 22 which is electrically connected to the electrical conductor 16. Alternatively, the detection device 20 may be arranged on the electrical conductor 16 or at a transition point from the electrical conductor 16 to the electrotechnical element 22. The decisive factor for the position of the detection device 20 is that the detection device 20 can detect the dripping medium 14 escaping due to the leakage, for example due to contamination with the dripping medium 14, outside the container 12.

The electrotechnical element 22 may be connected via the electrical conductor 16 to a second electrotechnical element 30 arranged inside the housing 12. Furthermore, the electrotechnical element 22 may comprise electrotechnical components 26, inter alia for controlling the second electrotechnical element 30, and a plug connection 24. The plug connection 24 may, for example, be configured to be accessible in a housing 28 of the electrotechnical element 22.

The device 10 may, for example, be a fuel tank device with a fuel heater. In this case, the container 12 is configured as a fuel tank for holding a fuel, preferably a diesel fuel, as the dripable medium 14. The electrotechnical element 22 comprises power and/or control electronics of the fuel heater, which is electrically connected via the electrical conductor 16 to a heating element arranged within the fuel tank, preferably with a positive temperature coefficient.

According to another example, the device 10 may be a traction battery device. In this case, the container 12 is a housing of a traction battery device in which electrical storage cells are surrounded by a coolant, preferably a transformer oil, as the dripable medium 14 for cooling. The electrical conductor 16 may comprise a high-voltage and/or a low-voltage connection, single conductors and/or, preferably polymer extruded, copper strands. The electrotechnical element 22 may comprise electronics and/or a connector. The electrical storage cells may be connected to an electrical machine or an electrical consumer, for example, for the transmission of electric energy via the electrical conductor 14 and the electrotechnical element 22.

FIG. 2 shows the detection device 20 arranged on the electrotechnical element 22 according to an embodiment. Furthermore, not only the electrical conductor 16 is surrounded by the sealing compound 18, but also the detection device 20 and the electrotechnical element 22.

The electrotechnical element 22 may comprise a printed circuit board 54 which is electrically connected to the electrical conductor 16, for example a busbar, by means of a press-fit connection 34. An insulating coating 36 may be provided at least in sections between the printed circuit board 54 and the press-fit connection 34 or the detection device 20.

With continued use, detachment areas 38 of the sealing compound 18 may form along the electrical conductor 16 and along the surface of the electrotechnical element 22. Over time, the dripable medium 14 that has escaped from the container 12 may penetrate into these detachment areas 38 and spread at least partially along the surface of the electrotechnical element 22, where it may be detected by the detection device 20.

The detection device 20 may comprise an arrangement of electrical contacts with an insulator or a material, e.g. a dry insulator or dielectric, which, when contaminated with the dripable medium 14, for example, leads to a measurable change in an applied electrical voltage and thus to a change in the electrical conductivity of the detection device 20, whereby the contamination with the dripable medium 14 and thus the leakage may be detected.

FIG. 4 schematically shows three examples of such an arrangement.

According to example (a), the detection device 20 comprises two electrical contacts 40B and an insulator 42B arranged between the electrical contacts 40B. The two electrical contacts 40B are force-loaded in the direction of the indicated arrows, i.e. they are pressed with a force F against the insulator 42B. A material is selected for the insulator 42B that dissolves when contaminated with the dripable medium 14. If this occurs, the application of force leads to electrical contact between the two electrical contacts 40B, which closes the normally open circuit. Accordingly, an applied current can flow via the two electrical contacts 40B, i.e. a detectable change in the electrical conductivity of the detection device 20 occurs, which may be evaluated accordingly. Example (a) may be described, for example, as a switching contact evaluation.

According to example (b), the detection device 20 comprises an electrode arrangement 40A, for example a capacitor, with a material 42A arranged within the electrode arrangement 40A, for example a dry insulator, which is configured to become electrically conductive when contaminated with the dripable medium 14 and thereby change the electrical conductivity of the detection device 20. Example (b) may be referred to as an ohmic detector, for example.

According to example (c), the electrode arrangement 40A forms a resonant circuit 50 with a coil 52. The permittivity of the material 42A may be changed by the contamination with the dripable medium 14 and thus a (significant) resonant circuit frequency shift between “dry” and “wet” may be detected. Example (c) can, for example, be described as a resonant circuit detector.

Such an arrangement that may be influenced by contamination according to these examples (a)-(c), for example the electrode arrangement 40A with the material 42A, may be electrically connected to a control unit 46 via a circuit 44 and an electrical connector 48, as shown schematically in FIG. 3.

The control unit 46 may be configured to apply electrical current to the electrode arrangement 40A or the electrical contacts 40B continuously, periodically and/or at predetermined times and to determine the change in the electrical conductivity of the detection device 20.

Furthermore, the control unit 46 may be connected, for example via the connector 24, to a motor vehicle control unit for transmitting detection information in terms of signal technology and/or electrically connected to a motor vehicle power supply. The control unit 46 may thus be supplied by the motor vehicle power supply with electrical current for applying current to the electrode arrangement 40A or the electrical contacts 40B. The detection information, which may in particular include information that a leakage has been detected, may be transmitted to the motor vehicle control unit and cause the motor vehicle control unit, for example, to send a control signal to a display device for issuing a warning. By means of the display device, which is arranged, for example, on the dashboard in the vehicle interior, the user may be warned of the detected leakage at an early stage and can initiate appropriate measures, e.g. repair of the defective seal.

The invention is not limited to the preferred embodiments described above. Rather, a large number of variants and modifications are possible which also make use of the inventive concept and therefore fall within the scope of protection. In particular, the invention also claims protection for the subject matter and the features of the dependent claims independently of the claims referred to. In particular, the individual features of independent claim 1 are each disclosed independently of one another. In addition, the features of the dependent claims are also disclosed independently of all the features of independent claim 1.

List of reference signs

| | |
|---|---|
| 10 | Device |
| 12 | Container |
| 14 | Dripable medium |
| 16 | Electrical conductor |
| 18 | Sealing compound |
| 20 | Detection device |
| 22 | Electrotechnical element |
| 24 | Plug connection |
| 26 | Electrotechnical components |
| 28 | Housing of the electrotechnical element |
| 30 | Second electrotechnical element |
| 32 | Conductor bushing |
| 34 | Press-fit connection |
| 36 | Insulating coating |
| 38 | Release areas of the sealing compound |
| 40A | Electrode arrangement |
| 40B | Electrical contacts |
| 42A, 42B | Insulator |
| 44 | Circuit |
| 46 | Control unit |
| 48 | Electrical connector |
| 50 | Resonant circuit |
| 52 | Coil |
| 54 | Printed circuit board |

1-16. (canceled)

17. A device with leakage detection of a dripable medium for a motor vehicle, the device comprising:
a container for holding the dripable medium;
an electrical conductor which is passed through a sealed conductor bushing of the container; and
a detection device arranged outside the container for detecting a leakage in the conductor bushing through which the dripable medium escapes from the container along the electrical conductor.

18. The device according to claim 17, wherein:
the motor vehicle is a utility vehicle; or
the dripable medium is a non-conductive dripable medium.

19. The device according to claim 17, wherein the electrical conductor outside the container is surrounded at least in sections by a sealing compound for sealing the conductor bushing, and the detection device is configured to detect the leakage by means of the leaked dripable medium, which has penetrated into a portion between the electrical conductor and the sealing compound.

20. The device according to claim 19, wherein:
the sealing compound is permanently elastic and/or adjacent to the container; or
the detection device with the electrical conductor is surrounded at least in sections by the sealing compound.

21. The device according to claim 17, wherein the electrical conductor outside the container is electrically connected to an electrotechnical element, and the detection device is arranged on the electrical conductor, at a transition point from the electrical conductor to the electrotechnical element and/or at the electrotechnical element.

22. The device according to claim 21, wherein the electrotechnical element with the detection device is surrounded by the sealing compound.

23. The device according to claim 21, wherein the electrotechnical element comprises a printed circuit board.

24. The device according to claim 21, wherein:
the electrotechnical element with the detection device is surrounded by the sealing compound in such a way that the dripable medium spreads at least partially on a surface of the electrotechnical element in the event of leakage and may be detected by the detection device; or
the electrotechnical element comprises a printed circuit board electrically connected to the electrical conductor by means of a press-fit connection.

25. The device according to claim 17, wherein the leakage is detectable by detecting a change in the electrical conductivity of the detection device when contaminated with the dripable medium.

26. The device according to claim 25, the detection device comprising two electrical contacts and an insulator arranged between the electrical contacts and configured to dissolve upon contamination with the dripable medium, wherein the contacts are force-loaded.

27. The device according to claim 25, the detection device comprising an electrode arrangement with a material arranged within the electrode arrangement, wherein a permittivity of the material may be changed by the contamination with the dripable medium.

28. The device according to claim 27, wherein the detection device comprises a resonant circuit with the electrode arrangement.

29. The device according to claim 28, wherein the permittivity of the material may be changed by the contamination with the dripable medium and thereby a resonant circuit frequency shift may be detected.

30. The device according to claim 25, the detection device further comprising a control unit which is signal-connected to a motor vehicle control unit for transmitting detection information and/or electrically connected to a motor vehicle power supply.

31. The device according to claim 25, wherein:
the detection device comprising two electrical contacts and an insulator arranged between the electrical contacts and configured to dissolve upon contamination with the dripable medium, wherein the contacts are force-loaded such that contacting of the electrical contacts occurs and thus the electrical conductivity of the detection device changes when the insulator dissolves; or
the detection device comprising an electrode arrangement with a material arranged within the electrode arrangement, wherein a permittivity of the material may be changed by the contamination with the dripable medium, the material becomes electrically conductive due to the contamination, and thereby the electrical conductivity of the detection device may be changed.

32. The device according to claim 21, wherein the container is a fuel tank for holding a fuel as the dripable medium.

33. The device according to claim 32, wherein:
the fuel is a diesel fuel; or
the electrotechnical element comprises power and/or control electronics of a fuel heater which is electrically connected via the electrical conductor to a heating element arranged inside the fuel tank.

34. The device according to claim 17, wherein the container is a housing of a traction battery device in which electrical storage cells are surrounded by a coolant for cooling as the dripable medium.

35. The device according to claim 34, wherein the coolant is a transformer oil.

36. The device according to claim 33, wherein:
the electrical conductor comprises a high-voltage and/or a low-voltage connection; or
the electrotechnical element comprises electronics and/or a connector; or
the electrical conductor comprises individual wires.

37. The device according to claim 36, wherein the electrical conductor comprises polymer-extruded, copper strands.

38. Motor vehicle comprising a device according to claim 17.

39. The motor vehicle of claim 28, wherein the motor vehicle is utility vehicle.
